(19) United States
(12) Patent Application Publication
(10) Pub. No.: US 2008/0008569 A1
(43) Pub. Date: Jan. 10, 2008

(54) Substrate transfer apparatus and substrate processing system using the same

(76) Inventor: Sang-Ho Seol, Pyeongtaek-si (KR)

Correspondence Address: HARNESS, DICKEY & PIERCE, P.L.C., P.O. BOX 8910, RESTON, VA, 20195, US

(21) Appl. No.: 11/655,182

(22) Filed: Jan. 19, 2007

(30) Foreign Application Priority Data
Jul. 4, 2006 (KR) 10-2006-0062671

(51) Int. Cl. B65G 1/00

(52) U.S. Cl. 414/287

(57) ABSTRACT

A substrate transfer apparatus includes first and second blades configured for supporting a substrate at different heights, respectively; an arm part connected to the first and second blades to move the first and second blades; and a drive unit configured for driving the first and second blades and the arm part, wherein the first and second blades are folded or unfolded while revolving on the same (single) axis of the arm part. According to the substrate transfer apparatus, a substrate processing throughput increases relative to a system area and time required for transferring and processing a substrate is reduced.

### CROSS-REFERENCE TO RELATED APPLICATIONS

This U.S. non-provisional patent application claims priority under 35 U.S.C §119 of Korean Patent Application 2006-62671 filed on Jul. 4, 2006, the entirety of which is hereby incorporated by reference.

### BACKGROUND

The present invention relates to a substrate processing system and, more specifically, to a substrate processing system which is capable of reducing a footprint area while increasing a substrate processing throughput.

A cluster system is generally referred to as a multi-chamber substrate processing system including a transfer robot (or handler) and a plurality of processing modules arranged around the transfer robot. In recent years, the demand of cluster systems having a batch-processing function is increasing for liquid crystal displays (LCDs), plasma display panels (PDPs), semiconductor manufacturing apparatuses etc. A cluster system includes, for example, a transfer chamber and a transfer robot which is rotatable inside the transfer chamber. A processing module, such as a process chamber, may be mounted on each side of the transfer chamber.

However, a conventional cluster system includes a transfer robot configured to transfer only one object (e.g., substrate) at a time and a process chamber in which only one object is processed. This leads to increase of total processing time required for processing a substrate inside the system. As a result, a production speed is reduced and the cost of end products increases.

### SUMMARY OF THE INVENTION

Exemplary embodiments of the present invention are directed to a substrate transfer apparatus for transferring a substrate to a process chamber. In an exemplary embodiment, the substrate transfer apparatus may include first and second blades configured for supporting a substrate at different heights, respectively; an arm part connected to the first and second blades to move the first and second blades; and a drive unit configured for driving the first and second blades and the arm part, wherein the first and second blades are folded or unfolded while revolving on the same axis of the arm part.

Exemplary embodiments of the present invention are directed to a substrate processing apparatus. In an exemplary embodiment, the substrate processing apparatus may include at least one process chamber with susceptors on which a substrate is loaded; a transfer chamber connected to the process chamber; and a substrate transfer apparatus installed inside the transfer chamber for simultaneously transferring substrates to the susceptors of the process chamber.

In another exemplary embodiment, the substrate transfer apparatus may include a transfer chamber; a pair of process chambers each having a susceptor, the pair of process chambers being juxtaposed at one side of the transfer chamber; and a substrate transfer apparatus installed inside the transfer chamber for simultaneously transferring substrates to susceptors of the pair of process chambers.

### BRIEF DESCRIPTION OF THE DRAWINGS

FIG. 1 is a top plan view illustrating a configuration of a substrate processing system according to the present invention.

FIG. 2 is a perspective view of a processing unit of the substrate processing system illustrated in FIG. 1.

FIG. 3 is a side sectional view of a processing unit illustrated in FIG. 2 to describe a substrate transfer apparatus installed at a transfer chamber.

FIG. 4 is a side sectional view of an exemplary drive unit configured to rotate first and second blades, an upper arm, and a lower arm.

FIG. 5A and FIG. 5B are a top plan view and a side sectional view of a processing unit where first and second blades of a substrate transfer apparatus overlap each other.

FIG. 6A and FIG. 6B are a top plan view and a side sectional view of a processing unit where first and second blades of a substrate transfer apparatus spread out.

FIG. 7 illustrates a processing unit where chambers each having one susceptor are juxtaposed.

FIG. 8 is an exemplary diagram illustrating an upper arm where first and second blade drive units are installed.

### DETAILED DESCRIPTION OF PREFERRED EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like numbers refer to like elements throughout.

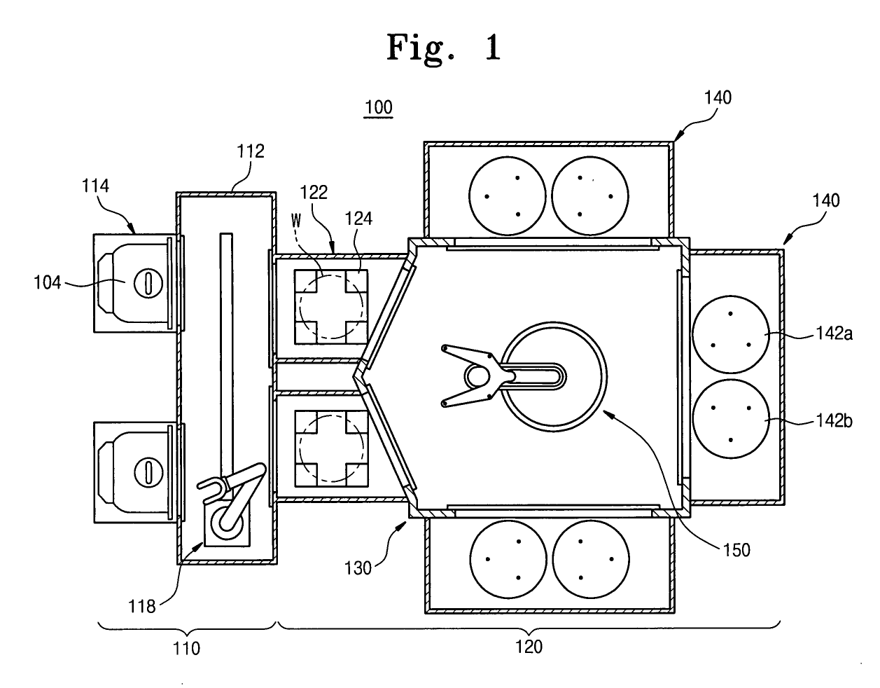

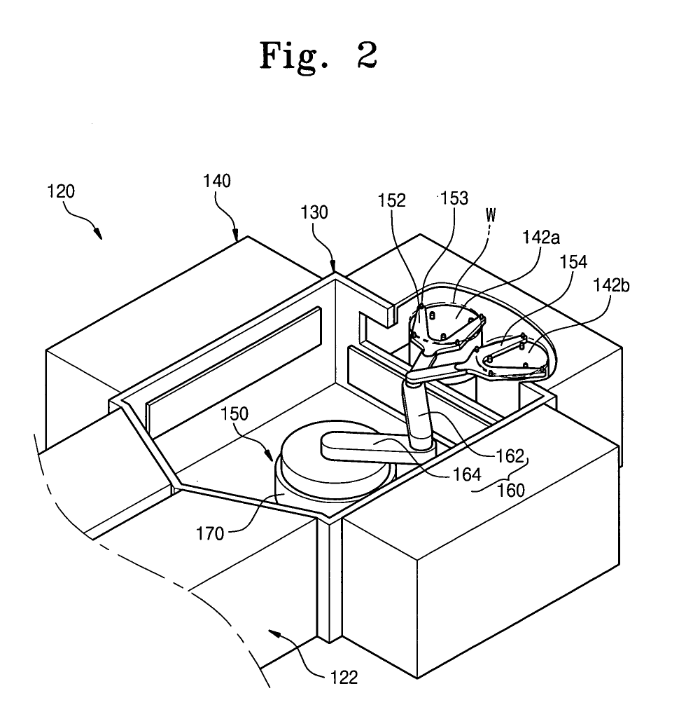

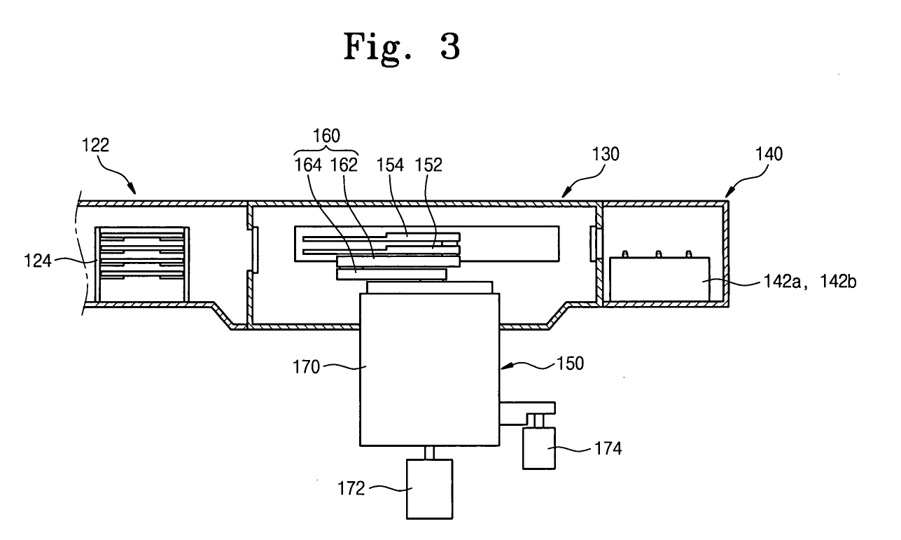

FIG. 1 is a top plan view illustrating a configuration of a substrate processing system according to the present invention, and FIG. 2 is a perspective view of a processing unit of the substrate processing system illustrated in FIG. 1. FIG. 3 is a side sectional view of a processing unit illustrated in FIG. 2 to describe a substrate transfer apparatus installed at a transfer chamber.

Referring to FIG. 1 through FIG. 3, an index 110 called an equipment front end module (EFEM) is installed at the substrate transfer system. The index 110 includes a frame 112 and a load station (or FOUP opener) 114 configured to open and close the cover of a FOUP (so-called “carrier”). Two FOUPs 104 each containing a substrate W are loaded on the load station 114 by means of a logistic automation system (e.g., OHT, AGV, RGV, etc.). The FOUPs 104 are typical lot carriers for manufacturing.

Inside the frame 112, a transfer robot 118 is installed to transfer a substrate W between the FOUP 104 loaded on the load station 114 and the processing unit 120. Namely when operating once, the transfer robot 118 takes out at least one substrate W from the FOUP 104 loaded on the load station 114 and carries the taken-out substrate W to a buffer stage 124 of a loadlock chamber 122. The transfer robot 118 installed at the index 110 may be one of various robots for use in semiconductor manufacturing processes.

As illustrated in FIG. 1, the processing unit 120 is disposed at the back of the index 110. The processing unit 120 includes two loadlock chambers 122, a transfer chamber 130, process chambers 140, and a substrate transfer apparatus 150.

The transfer chamber 130 is a polygonal chamber disposed at the center of the processing unit 120. Each of the loadlock chambers 122 is also disposed between the index 110 and the transfer chamber 130 and includes a buffer stage 124 on which a substrate to be processed or a processed substrate is placed. Conventionally, the loadlock chambers 122 function as buffer spaces between two different environments such as, for example, an atmospheric environment and a vacuum environment. A substrate to be processed (or a substrate processed in the process chamber) stays in the loadlock chamber 122 for a while.

The process chambers 140 are disposed at each side of the transfer chambers 130 to perform a predetermined process for two substrates, respectively. First and second susceptors 142a and 142b are juxtaposed inside the process chamber 140 to simultaneously perform a process for two substrates. The first and second susceptors 142a and 142b are disposed to face a substrate entrance. Although not shown in the figures, it will be understood that the first and second susceptors 142a and 142b have basic functions such as receiving/transferring a substrate from/to the substrate transfer apparatus 150 (which is conventionally done by means of a lift pin assembly installed at a susceptor), holding a substrate while processing the same, and offering a uniform thermal environment to a substrate according to a processing temperature.

The process chamber 140 may be configured for performing a variety of substrate processing operations. A process chamber may be, for example, an ashing chamber configured for removing a photoresist using plasma or a CVD chamber configured for depositing an insulation layer or an etch chamber configured for etching apertures or openings of an insulation layer to form interconnect structures or a PVD chamber configured for depositing a barrier layer or a PVD chamber configured for depositing a metal layer.

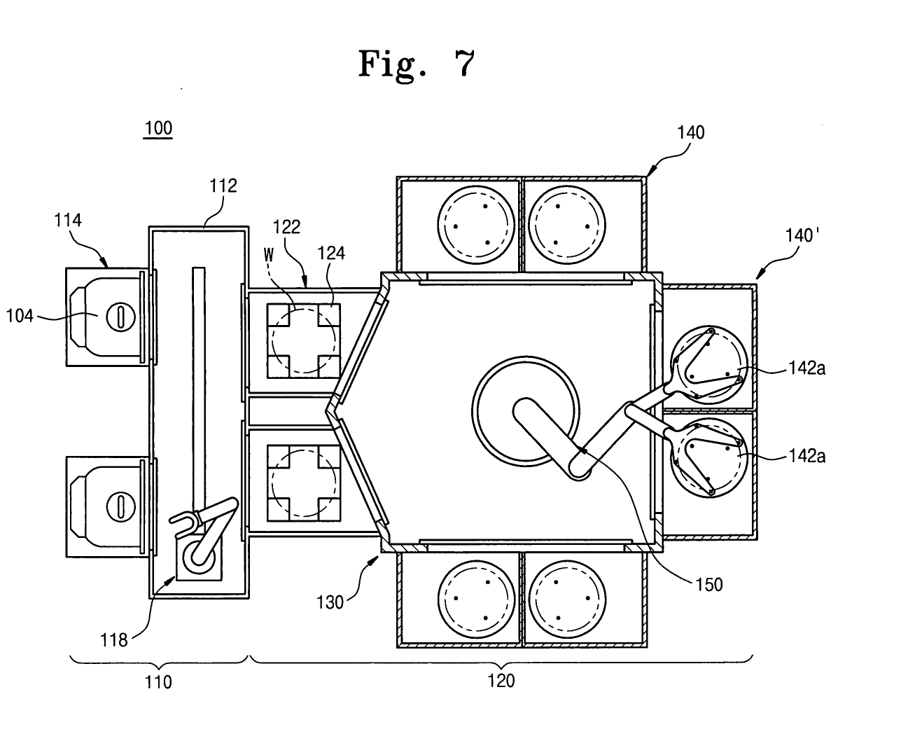

As illustrated in FIG. 7, two process chambers 140′ are juxtaposed at each side of a transfer chamber 130. Each of the process chambers 140′ includes a susceptor 142a. The same process may be performed at the process chambers 140′ juxtaposed at each side of the transfer chamber 130. In case of an etching (or deposition) process whose process conditions should be regulated minutely, one substrate is preferably processed inside each process chamber 140′ (see FIG. 7). In case of an ashing process whose process conditions need not be regulated minutely, a plurality of substrates may be processed inside one process chamber 140 (see FIG. 1).

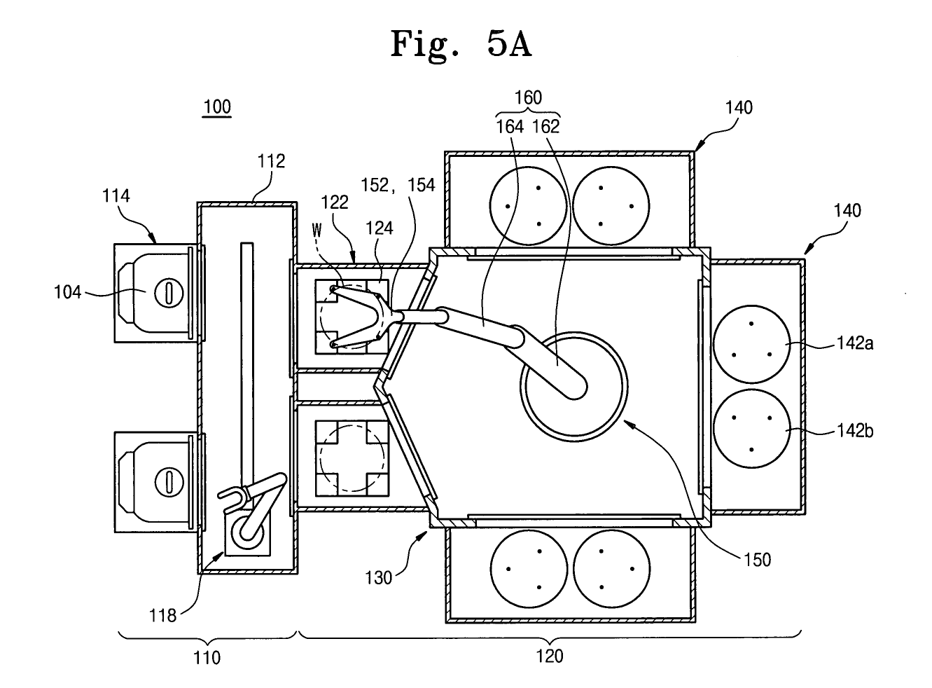

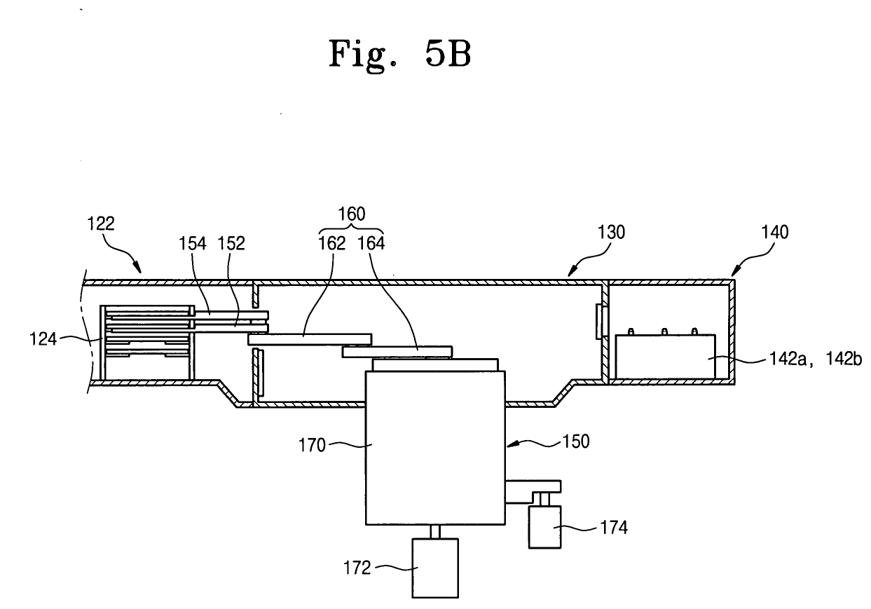

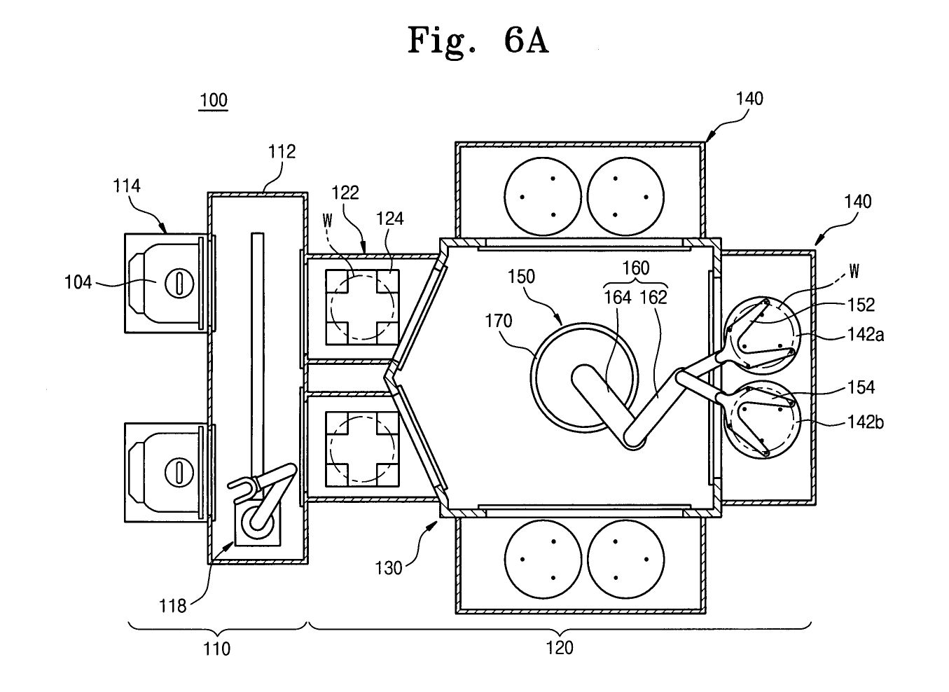

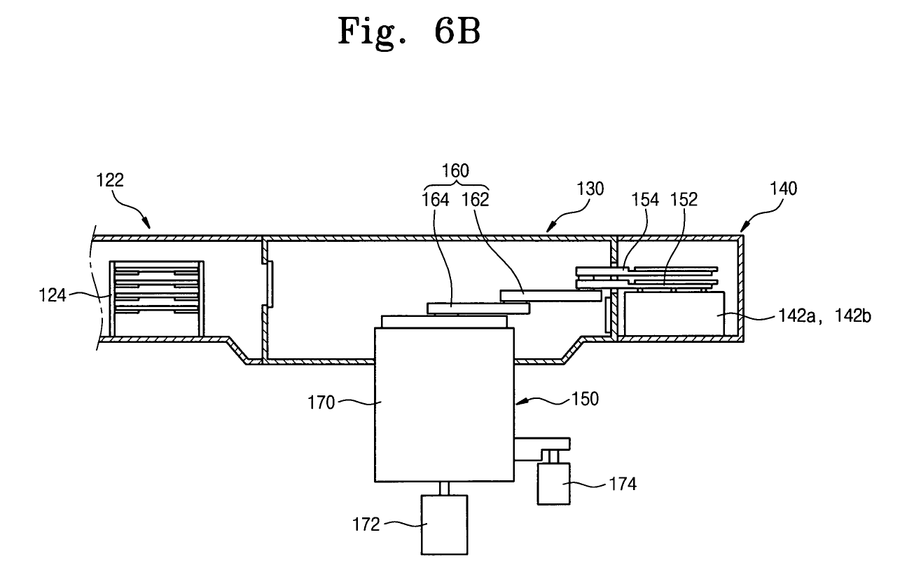

FIG. 5A and FIG. 5B are a top plan view and a side sectional view of a processing unit where first and second blades of a substrate transfer apparatus overlap each other. FIG. 6A and FIG. 6B are a top plan view and a side sectional view of a processing unit where first and second blades of a substrate transfer apparatus spread out.

As illustrated in FIG. 1 through FIG. 4, a substrate transfer apparatus 150 is installed at the transfer chamber 130. The substrate transfer apparatus 150 has a special structure to transfer two substrates per one operation.

The substrate transfer apparatus 150 includes first and second blades configured for loading/unloading two substrates to/from the first and second susceptors 142a and 142b of the process chamber 140 at one time. Especially, the substrate transfer apparatus 150 has a structure that is suitable for transferring substrates tothe process chamber 140 including the first and second susceptors 142a and 142b disposed side by side.

Further, the substrate transfer apparatus 150 includes first and second blades 152 and 154, an arm part 160, a rotation body 170, and a drive unit 180.

The rotation body 170 is a cylindrical body disposed at the center of the transfer chamber 130. The drive unit 180 is disposed inside the rotation body 170. The rotation body 170 is rotatable and elevatable on its axis by means of a rotation member 172 and an elevation member 174.

The arm part 160 includes an upper arm 162 and a lower arm 164 which revolve horizontally. One end of the upper arm 162 is coupled with the first and second blades 152 and 154, and one end of the lower arm 164 is coupled with the other end of the upper arm 162. The other end of the lower arm 164 is coupled with the rotation body 170. The fist and second blades 152 and 154 rotate on the same (single) axis of the upper arm 162. The upper arm 162 may rotate relatively to the lower arm 164. Further, the lower arm 164 rotates relatively to the rotation body 170.

The first and second blades 152 and 154 are sequentially stacked and revolvably installed at one end of the upper arm 162. Each of the first and second blades 152 and 154 has an aperture whose one side is open. Supports 153 are mounted on top surfaces of the first and second blades 152 and 154, respectively. The edge of a substrate is loaded on the support 153. The substrate transfer apparatus 150 may include a vacuum line (not shown) configured for selectively vacuum-absorbing a substrate to the support 153 of the first and second blades 152 and 154 or a edge clamp (not shown) configured for mechanically clamping the edge of a substrate.

The first and second blades 152 and 154 are folded or unfolded by a revolving operation on the same axis of the upper arm 162. The revolving directions of the first and second blades 152 and 154 are opposite to each other. As illustrated in FIG. 5A and FIG. 5B, the first blade 152 and the second blade 154 take out substrates W from the buffer stages 124 of the loadlock chamber 122 while they overlap each other. As illustrated in FIG. 6A and FIG. 6B, the first blade 152 and the second blade 154 deliver substrates W to the first and second susceptors 142a and 142b of the process chamber 140 while they are unfolded. As stated above, a substrate transfer apparatus may transfer two substrates at a time and direction of first and second blades may change while they are folded. Thus, a space of a transfer chamber may decrease.

The drive unit 180 includes first and second arm drive units 182 and 184 configured for horizontally revolving the upper and lower arms 162 and 164, respectively and first and second blade drive units 186 and 188 configured for oppositely revolving the first and second blades 152 and 154.

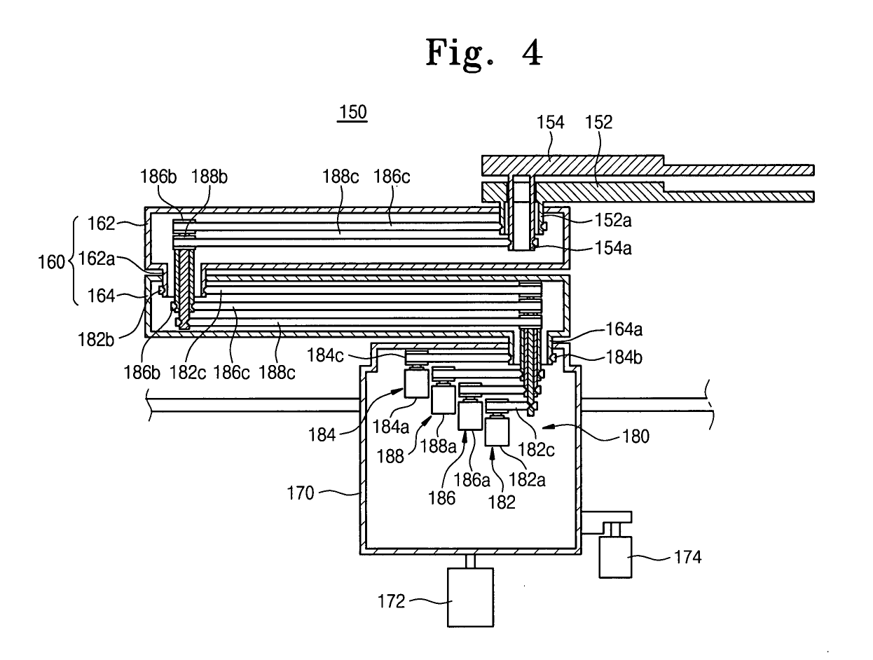

FIG. 4 is a side sectional view of an exemplary drive unit 170 configured to rotate first and second blades 152 and 154, an upper arm 162, and a lower arm 164.

Referring to FIG. 4, a lower arm rotation shaft 164a extends vertically downwardly to a rotation body 170 from one end of the lower arm 164. A second arm drive unit 184 revolves the lower arm 164 on the rotation body 170, about a lower arm rotation axis 164a. The second arm drive unit 184 includes a first drive motor 184a, a pulley 184b configured for transmitting a power of the first drive motor 184a to the lower arm rotation shaft 164a, and a belt 184c.

An upper arm rotation shaft 162a extends vertically downwardly to the lower arm 164 from one end of the upper arm 162. A first arm drive unit 182 revolves the upper arm 162 on the lower arm about a upper arm rotation shaft 162a. The first arm drive unit 182 includes a second drive motor 182a, a plurality of pulleys 182b configured for transmitting a power of the second drive motor 182a to the upper arm rotation shaft 162a, and a belt 182c.

A fitst blade rotation shaft 152a extends vertically downwardly to the upper arm 162 from one end of the first blade 152. The first blade drive unit 186 revolves the first blade 152 on the upper arm 162, on the basis of the first blade rotation axis 152a. A first blade drive unit 186 includes a third drive motor 186a, a plurality of pulleys 186b configured for transmitting a power of the third drive motor 186a to the first blade rotation axis 152a, and a belt 186c.

A second blade rotation shaft 154a extends vertically downwardly to the upper arm 164 through the first blade rotation shaft 152a from one end of the second blade 154. A second blade drive unit 188 revolves the second blade 154 on the upper arm 164, about the second blade rotation axis 154a. The second blade drive unit 188 includes a fourth drive motor 188a, a plurality of pulleys 188b configured for transmitting a power of the fourth drive motor 188a to the second blade rotation shaft 154a, and a belt 188c.

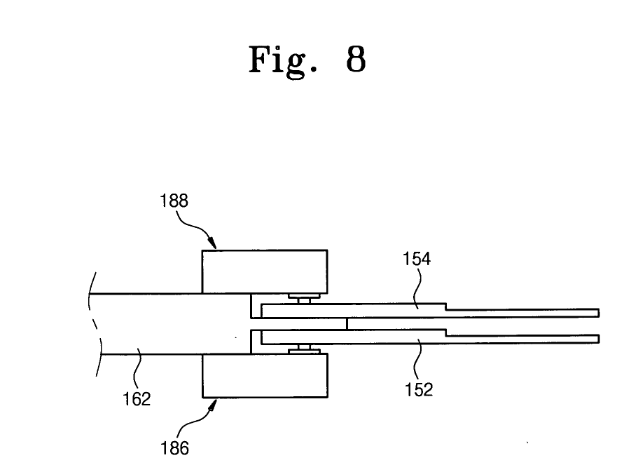

As illustrated in FIG. 8, the first and second blade drive units 186 and 188 are installed at the upper arm 164 to directly rotate the first and second blades 152 and 154, respectively. Likewise in the case where the first and second blade drive units 186 and 188 are installed at the upper arm 164, there is an advantage to omit a complex power transmission structure including a plurality of pulleys, a belt or the like.

As mentioned above, the lower arm rotation shaft 164a, the upper arm rotation shaft 162a, and the first and second blade rotation shafts 152a and 154a receive a power (rotation force) from their drive motors 182a, 184a, 186a, and 188a through mechanism such as a pulley (pulleys) and a belt, respectively.

The first and second drive motors 182a and 184a are independently controlled to locate the upper and lower arms 162 and 164 at a shrinkage (folded) position and an extension position, respectively. For example, the upper and lower arms 162 and 164 may be controlled to rotate by one arm drive unit. The third and fourth drive motors 186a and 188a are independently controlled to locate the first and second blades 152 and 154 at an overlap position (see FIG. 5A) and a bidirectionally unfolded position (see FIG. 6A).

The drive motors 182a, 184a, 186a, and 188a of the substrate transfer apparatus 150 are controlled by a controller with kinematical equations programmed to define the number of steps required for locating the arms 162 and 164 and the first and second blades 152 and 154 at target positions.

A procedure of transferring a substrate from a loadlock chamber to a process chamber using a substrate transfer apparatus will now be described below. Further, it will be understood that the present invention may be applied to transfer substrates between various chambers of a substrate processing system.

FIG. 5A and FIG. 5B illustrate the procedure that a substrate transfer apparatus takes out two substrates from a loadlock chamber. As illustrated in the figures, the first and second blades 152 and 154 take out two substrates W from a buffer stage 124 of a loadlock chamber 122 while first and second blades 152 and 154 overlap each other.

FIG. 6A and FIG. 6B illustrate the procedure that a substrate transfer apparatus loads two substrates taken out of a loadlock chamber on first and second susceptors of a process chamber. As illustrated in the figures, first and second blades 152 and 154 travel over first and second susceptors 142a and 142b of a process chamber 140 while they are unfolded in both-sided directions. Substrates W are lifted from the first and second blades 152 and 154 by lift pins ascending from a upper surface of the first and second susceptors 142a and 142b to loading position. At this time, the first and second blades 152 and 154 return to a standby position (where an upper arm and a lower arm are folded) of a transfer chamber 130. When the first and second blades 152 and 154 are taken out of the process chamber 140, lift pins are descended to place a substrate W on the first and second susceptors 142a and 142.

According to the present invention, a substrate processing system is capable of reducing a footprint area while increasing a substrate processing throughput. Further, the substrate processing system is capable of reducing time required for transferring and processing a substrate.

Although the present invention has been described in connection with the embodiment of the present invention illustrated in the accompanying drawings, it is not limited thereto. It will be apparent to those skilled in the art that various substitutions, modifications and changes may be made without departing from the scope and spirit of the invention.

What is claimed is:

1. A substrate transfer apparatus for transferring a substrate to a process chamber, comprising:
first and second blades configured for supporting a substrate at different heights, respectively;
an arm part connected to the first and second blades to move the first and second blades; and
a drive unit configured for driving the first and second blades and the arm part,
wherein the first and second blades are folded or unfolded while revolving on the same axis of the arm part.

2. The substrate transfer apparatus of claim 1, wherein the first and second blades revolve in opposite directions.

3. The substrate transfer apparatus of claim 1, wherein the drive unit comprises first and second blade drive units configured for revolving the first and second blades in opposite directions about a connection shaft by which the first and second blades are connected to the arm part.

4. The substrate transfer apparatus of claim 1, wherein the arm part comprises:
an upper arm to which one end of the first blade and one end of the second blade are connected; and
a lower arm disposed below the upper arm to be connected to the upper arm.

5. The substrate transfer apparatus of claim 4, wherein the drive unit comprises:
a first and second blade drive unit configured for revolving the first and second blades in opposite directions about a connection shaft by which the first and second blades are connected to the arm part; and
at least one arm drive unit configured for horizontally revolving the upper and lower arms.

6. The substrate transfer apparatus of claim 1, wherein each of the first and second blades has a shape of horseshoe with an aperture whose one side is open and a support on which the edge of a substrate is placed.

7. A substrate processing system comprising:
at least one process chamber with susceptors on which a substrate is loaded;
a transfer chamber connected to the process chamber; and
a substrate transfer apparatus installed inside the transfer chamber for simultaneously transferring substrates to the susceptors of the process chamber.

8. The substrate processing system of claim 7, wherein the process chamber includes a first susceptor and a second susceptor which are juxtaposed toward an entrance through which substrates pass, the substrates transfer apparatus comprises first and second blades configured for supporting a substrate at different heights and transferring a substrate while they are folded or unfolded by a revolving operation on the same axis.

9. The substrate processing system of claim 7, further comprising:
a loadlock chamber with at least two stacked buffer stages on which a substrate is loaded,
wherein the substrate transfer apparatus takes or puts a substrate from/to the buffer stages of the loadlock chamber while the first and second blades overlap each other.

10. The substrate processing system of claim 8, wherein the first and second blades revolve in opposite directions.

11. The substrate processing system of claim 8, wherein the substrate transfer apparatus comprises:
an arm part connected to the first and second blades to move the first and second blades; and
a drive unit configured for driving the first and second blades and the arm part.

12. The substrate processing system of claim 11, wherein the drive unit comprises a first and second blade drive unit configured for revolving the first and second blades in opposite directions about a connection shaft by which the first and second blades are connected to the arm part.

13. The substrate processing system of claim 11, wherein the arm part comprises:
an upper arm to which one end of the first blade and one end of the second blade are connected; and
a lower arm disposed below the upper arm to be connected to the upper arm.

14. The substrate processing system of claim 13, wherein the drive unit further comprises at least one arm drive unit configured for horizontally revolving the upper and lower arms.

15. A substrate processing system comprising:
a transfer chamber;
a pair of process chambers each having a susceptor, the pair of process chambers being juxtaposed at one side of the transfer chamber; and
a substrate transfer apparatus installed inside the transfer chamber for simultaneously transferring substrates to susceptors of the pair of process chambers.

16. The substrate processing system of claim 15, wherein the substrate transfer apparatus comprises first and second blades configured for supporting a substrate at different heights and transferring a substrate while they are folded or unfolded by a revolving operation on the same axis line.

17. The substrate processing system of 16, wherein the pair of process chambers are configured for performing the same process.
